(19) United States
(12) Patent Application Publication
(10) Pub. No.: US 2026/0293931 A1
(43) Pub. Date: Oct. 1, 2026

(54) STIRRING BARREL AND BEVERAGE MAKER

(71) Applicant: FOSHAN BINGFEN INTELLIGENT TECHNOLOGY CO., LTD., FOSHAN (CN)

(72) Inventors: CHENGYOU LIN, FOSHAN (CN); FENQIANG ZOU, FOSHAN (CN); YIFEI YU, FOSHAN (CN)

(73) Assignee: FOSHAN BINGFEN INTELLIGENT TECHNOLOGY CO., LTD., FOSHAN (CN)

(21) Appl. No.: 19/417,571

(22) Filed: Dec. 12, 2025

(30) Foreign Application Priority Data
Apr. 1, 2025 (CN) 202530169826.X
Apr. 14, 2025 (CN) 202520698346.7
Apr. 14, 2025 (CN) 202520698781.X
Apr. 14, 2025 (CN) 202520701177.8
Apr. 14, 2025 (CN) 202520701215.X
Apr. 14, 2025 (CN) 202520701252.0
Apr. 14, 2025 (CN) 202520701278.5
Apr. 14, 2025 (CN) 202520701315.2

(51) Int. Cl. A23G 9/16; A23G 9/04; A23G 9/22

(52) U.S. Cl. CPC A23G 9/166; A23G 9/045; A23G 9/222; A23G 9/224

(57) ABSTRACT

The present disclosure provides a stirring barrel and a beverage maker. The stirring barrel is applied to the beverage maker. The stirring barrel includes a barrel body, a guide member, and a stirring and refrigeration assembly, where the barrel body is disposed on the housing assembly; the barrel body is provided with a feed port and an accommodating cavity; the feed port is provided with an extension portion; the guide member is disposed in the barrel body and corresponds to the feed port; the guide member is provided with an input port; and the stirring and refrigeration assembly is configured to stir and refrigerate raw materials injected into the accommodating cavity. The beverage maker includes the stirring barrel. The present disclosure can prevent splashing of the raw materials from the feed port to improve the user experience.

### TECHNICAL FIELD

The present disclosure relates to the technical field of beverage makers, and in particular to a stirring barrel and a beverage maker.

### BACKGROUND

A beverage maker, also referred to as a frozen beverage maker, a crushed-ice beverage maker or a slush maker, usually includes a stirring barrel configured to mix raw materials and regulate a temperature. For example, the stirring barrel is configured to transform the raw materials into frozen or semi-frozen products such as slush, smoothie, and ice cream. Typically, the stirring barrel is provided with a feed port. The raw materials are injected into the stirring barrel through the feed port, enabling the stirring barrel to stir and cool the raw materials.

When the existing beverage maker is used, in case of excessively quick injection of the raw materials from the feed port of the stirring barrel, the raw materials will splash out of the feed port easily, causing contamination to the beverage maker and the worktable to affect the user experience.

### SUMMARY

A technical problem to be solved by the present disclosure is to provide a stirring barrel. The present disclosure can prevent splashing of raw materials from the feed port during injection of the raw materials, so as not to contaminate the beverage maker and the worktable to improve the user experience.

In order to solve the above technical problem, the present disclosure provides a stirring barrel, which is applied to a beverage maker, where the beverage maker includes a housing assembly and a drive assembly; the drive assembly is disposed in the housing assembly; and the stirring barrel includes: a barrel body, where the barrel body is disposed on the housing assembly; the barrel body is provided with a feed port and an accommodating cavity; the feed port communicates with the accommodating cavity; and the feed port is provided with an extension portion;

a guide member, where the guide member is disposed in the barrel body; the guide member corresponds to the feed port; the guide member is provided with an input port; the input port communicates with the accommodating cavity and the feed port; and the extension portion is configured to block the input port; and

a stirring and refrigeration assembly, where the stirring and refrigeration assembly is disposed in the accommodating cavity; the stirring and refrigeration assembly is connected to the drive assembly; and the stirring and refrigeration assembly is configured to stir and refrigerate raw materials injected into the accommodating cavity.

As an improvement to the above solution, one end of the barrel body is further provided with a front end plate; a lower portion of the front end plate is provided with an output port; the output port is provided with an output valve; and the output valve is configured to seal or open the output port;

an upper surface of an end of the barrel body away from the feed port is provided with an arc-shaped curved surface that is smoothly arranged; the arc-shaped curved surface is disposed between an upper surface of an inner wall of the barrel body and the front end plate; and the arc-shaped curved surface gradually curves and transitions from the upper surface of the inner wall of the barrel body toward the lower portion of the front end plate; and

the arc-shaped curved surface smoothly extends along a circumferential side of the barrel body from one side of the barrel body to the other side of the barrel body.

As an improvement to the above solution, the stirring barrel further includes: a rear shell assembly, where the rear shell assembly is provided with a mounting hole;
a sealing assembly, where the sealing assembly is provided with a sealing hole; the sealing assembly is disposed on the rear shell assembly; the sealing assembly is disposed along a circumferential direction of the mounting hole; the sealing assembly includes one part located at a first side of the rear shell assembly, and the other part extending to a second side of the rear shell assembly after passing through the mounting hole; and the second side is opposite to the first side;
a refrigerating barrel, where the refrigerating barrel includes a refrigerating barrel body and a sealing plate; the refrigerating barrel body partially passes through the sealing hole from the first side of the rear shell assembly and extends out from the second side of the rear shell assembly; the sealing plate is located at an end of the refrigerating barrel body extending to the second side and disposed around the refrigerating barrel body; and the sealing assembly is partially clamped between the sealing plate and the second side of the rear shell assembly; and
a front shell assembly, where the front shell assembly is disposed on the rear shell assembly and located at the first side of the rear shell assembly; the sealing assembly is partially clamped between the first side of the rear shell assembly and the front shell assembly; and the front shell assembly includes the guide member;
the sealing assembly includes a sealing ring, a connecting portion, and an external extension portion; the sealing ring is provided with the sealing hole; one side of the external extension portion is connected to a side of the connecting portion away from the sealing ring; and the sealing ring, the connecting portion, and the external extension portion cooperate to form a first sealing groove; and
a central axis of the sealing ring coincides with a central axis of the refrigerating barrel; and a distance from a central axis of the external extension portion to a bottom of the barrel body is greater than a distance from the central axis of the sealing ring to the bottom of the barrel body.

As an improvement to the above solution, the guide member includes a guide bottom plate and an output side plate; an end of the guide bottom plate away from the extension portion serves as a first end; the first end of the guide bottom plate corresponds to the feed port; an end of the guide bottom plate close to the extension portion serves as a second end; the second end of the guide bottom plate is connected to the output side plate; and a preset included angle is formed between the guide bottom plate and the output side plate;
the extension portion can block the output side plate and block at least a part of the guide bottom plate; and
the guide bottom plate is obliquely disposed; the first end of the guide bottom plate extends obliquely downward to the second end of the guide bottom plate; and a height of the first end of the guide bottom plate is greater than a height of the second end of the guide bottom plate.

As an improvement to the above solution, the input port is formed in the output side plate; the input port includes a plurality of through holes; and the plurality of through holes are disposed at intervals; and
a junction between the guide bottom plate and the output side plate is arc-shaped; the plurality of through holes are formed at the junction between the guide bottom plate and the output side plate; and the plurality of through holes each extend from the output side plate to the second end of the guide bottom plate.

As an improvement to the above solution, the sealing assembly further includes a first sealing fin and a second sealing fin; the first sealing fin and the connecting portion are disposed on the sealing ring and respectively located at two sides of the sealing ring; and the second sealing fin is disposed on the external extension portion and located at a side of the external extension portion away from the connecting portion.

As an improvement to the above solution, the external extension portion includes an extension portion body and a second sealing convex rib; the extension portion body is clamped between the rear shell assembly and the front shell assembly; and the second sealing convex rib is disposed on the extension portion body and located between the extension portion body and the front shell assembly.

As an improvement to the above solution, the front shell assembly further includes a front shell body; the front shell body is disposed on the rear shell assembly and located at the first side of the rear shell assembly; the guide member is disposed at one side of the front shell body; the front shell body is provided with an adapting port; and the refrigerating barrel passes through the adapting port.

As an improvement to the above solution, the rear shell assembly includes a rear shell body, a sealing convex ring, and a limiting rib; the rear shell body is provided with the mounting hole; the sealing convex ring is disposed at a first side of the rear shell body; the sealing convex ring surrounds the mounting hole; the limiting rib is located outside the sealing convex ring and forms a second sealing groove with the sealing convex ring; and the sealing assembly is sleeved on the sealing convex ring and partially extends to the second sealing groove; and
a front convex rib is further disposed on the front shell body; the front convex rib surrounds the adapting port and protrudes outward; and the front convex rib can abut against the sealing assembly at the second sealing groove.

As an improvement to the above solution, the sealing ring includes a sealing ring body and a first sealing convex rib; the sealing ring body is clamped between a wall of the mounting hole and an outer wall of the refrigerating barrel; and the first sealing convex rib is disposed on the sealing ring body, and located between the sealing ring body and the outer wall of the refrigerating barrel.

The present disclosure further provides a beverage maker, including the stirring barrel described above.

The implementation of the present disclosure has the following beneficial effects:

The stirring barrel provided by the present disclosure is applied to the beverage maker. The beverage maker includes the housing assembly and the drive assembly. The drive assembly is disposed in the housing assembly. The stirring barrel includes the barrel body, the guide member, and the stirring and refrigeration assembly. The barrel body is disposed on the housing assembly. The barrel body is provided with the feed port and the accommodating cavity. The feed port communicates with the accommodating cavity. The feed port is provided with the extension portion. The guide member is disposed in the barrel body. The guide member corresponds to the feed port. The guide member is provided with the input port. The input port communicates with the accommodating cavity and the feed port. The extension portion is configured to block the input port. The stirring and refrigeration assembly is disposed in the accommodating cavity. The stirring and refrigeration assembly is connected to the drive assembly. The stirring and refrigeration assembly is configured to stir and refrigerate raw materials injected into the accommodating cavity. The present disclosure realizes accurate injection of the raw materials, and performs stirring and refrigeration on the injected raw materials, thereby forming a frozen or semi-frozen product. The present disclosure blocks the input port of the guide member through the extension portion at the feed port. When the raw materials are to be injected, the raw materials enter the guide member through the feed port, and the raw materials are guided to the input port through the guide member and flows to the accommodating cavity through the input port. With the extension portion for blocking the input port, the present disclosure realizes injection of the raw materials, and prevents splashing of the raw materials from the feed port in case of an excessively quick injection speed of the raw materials, thereby avoiding contamination to the beverage maker and the worktable to improve the user experience.

### BRIEF DESCRIPTION OF THE DRAWINGS

FIG. 1 is a schematic view of a split structure of a stirring barrel, a housing assembly, and a drive assembly according to the present disclosure;

FIG. 2 is a schematic view of a split structure of a barrel body and a guide member from a first viewing angle according to the present disclosure;

FIG. 3 is a schematic view of a split structure of a barrel body and a guide member from a second viewing angle according to the present disclosure;

FIG. 4 is a schematic sectional view of a barrel body according to the present disclosure;

FIG. 5 is a partially enlarged view of A shown in FIG. 4;

FIG. 6 is a schematic view of a split structure of a rear shell assembly, a sealing assembly, a front shell assembly, and a refrigerating barrel from a first viewing angle according to the present disclosure;

FIG. 7 is a schematic sectional view of a sealing assembly according to the present disclosure;

FIG. 8 is a partially enlarged view of B shown in FIG. 7;

FIG. 9 is a schematic structural view of a rear shell assembly according to the present disclosure;

FIG. 10 is a schematic view of a split structure of a rear shell assembly, a sealing assembly, a front shell assembly, and a refrigerating barrel from a second viewing angle according to the present disclosure; and

FIG. 11 is a schematic structural view of a barrel body according to the present disclosure.

### DETAILED DESCRIPTION

In order to make the objectives, technical solutions, and advantages of the present disclosure more clear, the present disclosure will be further described in detail below with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

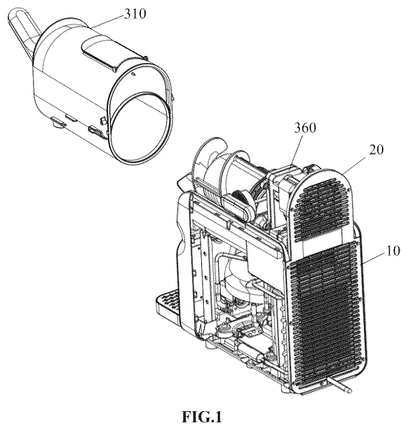

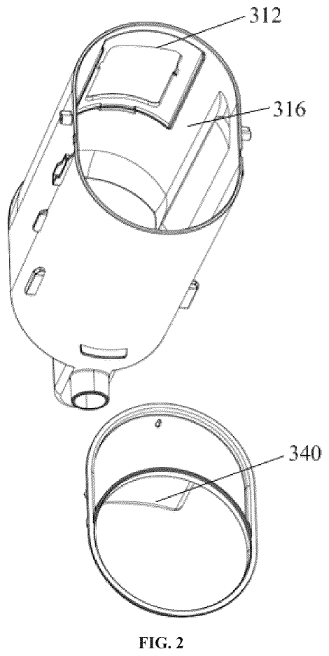

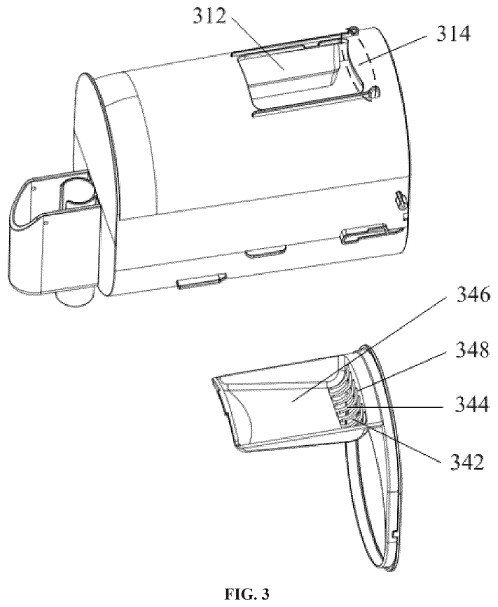

In an embodiment, as shown in FIG. 1, FIG. 2, and FIG. 3, a stirring barrel is provided, and applied to a beverage maker. The beverage maker includes a housing assembly 10 and a drive assembly 20. The drive assembly 20 is disposed in the housing assembly 10. The stirring barrel includes a barrel body 310, a guide member 340, and a stirring and refrigeration assembly 360. The barrel body 310 is disposed on the housing assembly 10. The barrel body 310 is provided with a feed port 312 and an accommodating cavity 316. The feed port 312 communicates with the accommodating cavity 316. The feed port 312 is provided with an extension portion 314. The guide member 340 is disposed in the barrel body 310. The guide member 340 corresponds to the feed port 312. The guide member 340 is provided with an input port 342. The input port 342 communicates with the accommodating cavity 316 and the feed port 312. The extension portion 314 is configured to block the input port 342. The stirring and refrigeration assembly 360 is disposed in the accommodating cavity 316. The stirring and refrigeration assembly 360 is connected to the drive assembly 20. The stirring and refrigeration assembly 360 is configured to stir and refrigerate raw materials injected into the accommodating cavity 316.

The barrel body 310 may be made of a metal material or a non-metal material. The barrel body 310 is detachably disposed on the housing assembly 10. The accommodating cavity 316 is configured to accommodate the stirring and refrigeration assembly 360, and may further be configured to accommodate injected raw materials. Since the barrel body 310 is further provided with the feed port 312, and the feed port 312 communicates with the accommodating cavity 316, such that the raw materials can be injected into the accommodating cavity 316 through the feed port 312. The feed port 312 is provided with the extension portion 314. The extension portion 314 and the barrel body 310 are of an integrally formed structure. The extension portion 314 covers a part of the feed port 312, so as to block the input port 342 below the extension portion 314.

The guide member 340 partially corresponds to the feed port 312. The guide member 340 may be disposed in the barrel body 310 by snap-fitting. After the raw materials are injected through the feed port 312, the raw materials are guided to the input port 342 through the guide member 340, and then the raw materials are injected into the accommodating cavity 316 of the barrel body 310 through the input port 342. Exemplarily, the guide member 340 has an opening. The opening of the guide member 340 corresponds to the feed port 312. The input port 342 of the guide member 340 is disposed below the extension portion 314, so as to block the input port 342 through the extension portion 314. When the raw materials are injected, the extension portion 314 can prevent splashing of the raw materials from the feed port 312 when the raw materials enter the input port 342, thereby avoiding contamination to the beverage maker and the worktable to improve the user experience.

The stirring and refrigeration assembly 360 includes a stirring module and a refrigeration module. The refrigeration module may be an evaporator. The evaporator communicates with a compressor and a condenser. The stirring module is connected to the drive assembly 20. The stirring module is provided with a plurality of stirring blades, and can be configured to stir and cool the raw materials injected into the accommodating cavity 316, thereby forming a frozen or semi-frozen product.

The present disclosure blocks the input port 342 of the guide member 340 through the extension portion 314 at the feed port 312. When the raw materials are to be injected, the raw materials enter the guide member 340 through the feed port 312, and the raw materials are guided to the input port 342 through the guide member 340 and flows to the accommodating cavity 316 through the input port 342. With the extension portion 314 for blocking the input port 342, the present disclosure realizes injection of the raw materials, and prevents splashing of the raw materials from the feed port 312 in case of an excessively quick injection speed of the raw materials, thereby avoiding contamination to the beverage maker and the worktable to improve the user experience.

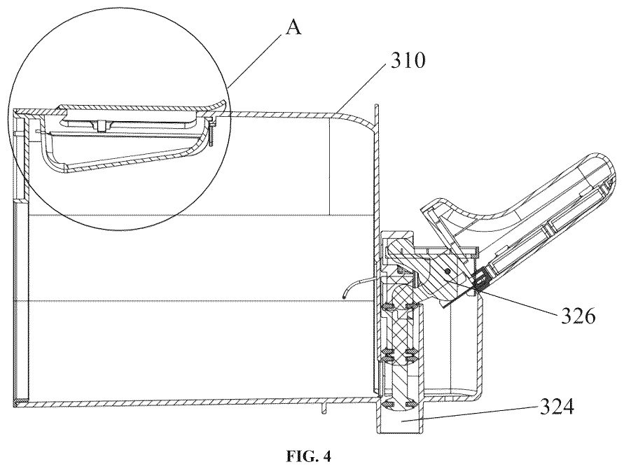

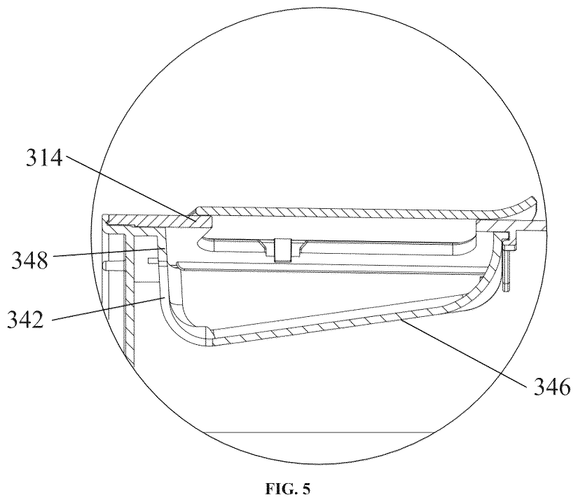

In an embodiment, as shown in FIG. 3, FIG. 4 and FIG. 5, the guide member 340 includes a guide bottom plate 346 and an output side plate 348. An end of the guide bottom plate 346 away from the extension portion 314 serves as a first end. The first end of the guide bottom plate 346 corresponds to the feed port 312. An end of the guide bottom plate 346 close to the extension portion 314 serves as a second end. The second end of the guide bottom plate 346 is connected to the output side plate 348. A preset included angle is formed between the guide bottom plate 346 and the output side plate 348. The input port 342 is formed in the output side plate 348. The extension portion 314 is configured to block the output side plate 348.

The guide bottom plate 346 and the output side plate 348 may be of an integrally formed structure. The first end of the guide bottom plate 346 is disposed below the feed port 312. When the raw materials enter the feed port 312, the raw materials can be guided and conveyed to the second end of the guide bottom plate 346 through the first end of the guide bottom plate 346. The output side plate 348 is located below the extension portion 314, such that the extension portion 314 can completely block the input port 342 of the output side plate 348. When the raw materials are injected, the extension portion 314 can prevent splashing of the raw materials from the feed port 312 when the raw materials enter the input port 342. In an embodiment, as shown in FIG. 3 and FIG. 4, the extension portion 314 is further configured to block at least a part of the guide bottom plate 346.

In an embodiment, as shown in FIG. 3, FIG. 4 and FIG. 5, the guide bottom plate 346 is obliquely disposed. The first end of the guide bottom plate 346 extends obliquely downward to the second end of the guide bottom plate 346. A height of the first end of the guide bottom plate 346 is greater than a height of the second end of the guide bottom plate 346. The height of the first end of the guide bottom plate 346 refers to a height from the first end of the guide bottom plate 346 to a bottom of the barrel body. The height of the second end of the guide bottom plate 346 refers to a height from the second end of the guide bottom plate 346 to the bottom of the barrel body. Since the height of the first end of the guide bottom plate 346 is greater than the height of the second end of the guide bottom plate 346, the raw materials can be quickly guided and conveyed to the second end of the guide bottom plate 346 through the first end of the guide bottom plate 346, and the raw materials are conveyed to the accommodating cavity 316 through the input port 342 in the output side plate 348, thereby improving the conveyance efficiency of the raw materials.

The input port 342 is formed in the output side plate 348. The input port 342 includes a plurality of through holes 344. The plurality of through holes 344 are disposed at intervals. A junction between the guide bottom plate 346 and the output side plate 348 is arc-shaped, such that the junction between the guide bottom plate 346 and the output side plate 348 is in arc transition. The plurality of through holes are formed at the junction between the guide bottom plate 346 and the output side plate 348. The plurality of through holes 344 each extend from the output side plate 348 to the second end of the guide bottom plate 346. When the raw materials are injected, the raw materials enter the first end of the guide bottom plate 346 through the feed port 312, are guided and conveyed to the second end of the guide bottom plate 346 through the first end of the guide bottom plate 346, and flow to the accommodating cavity 316 through the input port 342. This reduces a resistance when the raw materials are conveyed from the guide bottom plate 346 to the input port 342 of the output side plate 348, and reduces splashing when the raw materials are injected into the input port 342.

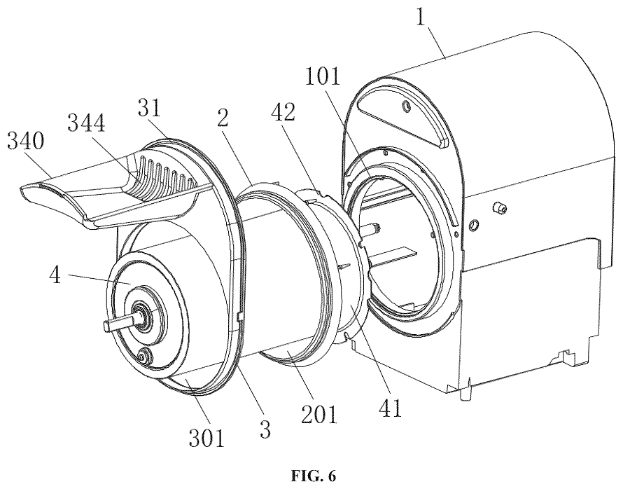

As shown in FIG. 6, in an embodiment, the stirring barrel further includes a rear shell assembly 1, a sealing assembly 2, a front shell assembly 3, and a refrigerating barrel 4. The rear shell assembly 1 is provided with a mounting hole 101. The sealing assembly 2 is provided with a sealing hole 201. The sealing assembly 2 is disposed on the rear shell assembly 1. The sealing assembly 2 is disposed along a circumferential direction of the mounting hole 101. One part of the sealing assembly 2 is located at a first side of the rear shell assembly 1. The other part of the sealing assembly 2 extends to a second side of the rear shell assembly 1 after passing through the mounting hole 101. The second side is opposite to the first side. The front shell assembly 3 includes the guide member 340. The guide member 340 is disposed at a side of the front shell assembly 3 away from the rear shell assembly 1. The front shell assembly 3 is disposed on the rear shell assembly 1 and located at the first side of the rear shell assembly 1. The sealing assembly 2 is partially clamped between the first side of the rear shell assembly 1 and the front shell assembly 3. The front shell assembly 3 can obstruct and guide raw materials flowing out from the guide member 340, while the sealing assembly 2 can prevent the raw materials from flowing to the refrigerating barrel 4 or the rear shell assembly 1. The refrigerating barrel 4 passes through the sealing hole 201 from the first side of the rear shell assembly 1 and extends out from the second side of the rear shell assembly 1. The sealing assembly 2 is partially clamped between the refrigerating barrel 4 and the second side of the rear shell assembly 1.

When the refrigerating barrel 4 passes through the sealing hole 201, the sealing assembly 2 firmly wraps the refrigerating barrel 4, with one part clamped between the refrigerating barrel 4 and the second side of the rear shell assembly 1, and the other part clamped between the first side of the rear shell assembly 1 and the front shell assembly 3. Such a firmly attached state can minimize the gap to realize efficient sealing. Even though the device suffers from vibration or slight deformation, the sealing assembly 2 can also keep a desirable sealing state with elasticity to ensure stability of an environment in the device. The sealing assembly 2 usually has a certain degree of elasticity. It can play a buffering role when the device suffers an external impact, absorbing a part of the impact force to protect the rear shell assembly 1, the refrigerating barrel 4, and the front shell assembly 3.

The refrigerating barrel 4 includes a refrigerating barrel body 41 and a sealing plate 42. The refrigerating barrel body 41 partially passes through the sealing hole 201 from the first side of the rear shell assembly 1 and extends out from the second side of the rear shell assembly 1. The sealing plate 42 is located at an end of the refrigerating barrel body 41 extending to the second side and disposed around the refrigerating barrel body 41. The sealing assembly 2 is partially clamped between the sealing plate 42 and the second side of the rear shell assembly 1. The refrigerating barrel body 41 passes through the sealing hole 201 of the sealing assembly 2. The sealing plate 42 is disposed around the end of the refrigerating barrel body 41 extending to the second side of the rear shell assembly 1. The sealing assembly 2 is partially clamped between the sealing plate 42 and the second side of the rear shell assembly 1 to form a sealing protection line. The sealing plate 42 cooperates with the sealing assembly 2 and the rear shell assembly 1, such that a position of the refrigerating barrel 4 can be effectively fixed. It limits axial and radial displacements of the refrigerating barrel 4, such that the refrigerating barrel 4 operates more stably.

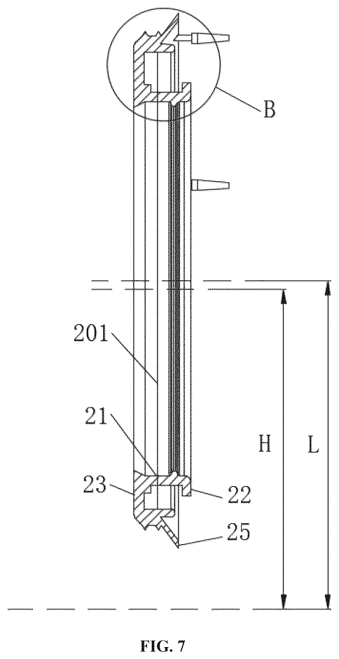

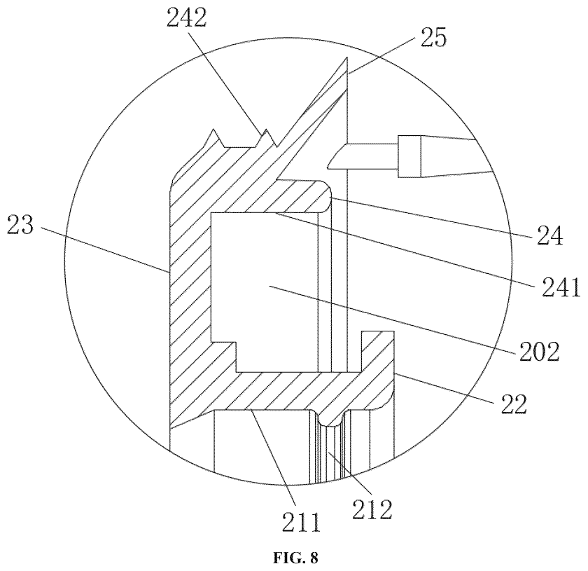

As shown in FIG. 7 and FIG. 8, in an embodiment, the sealing assembly 2 includes a sealing ring 21, a first sealing fin 22, a connecting portion 23, an external extension portion 24, and a second sealing fin 25. The sealing ring 21 is provided with the sealing hole 201. The first sealing fin 22 and the connecting portion 23 are disposed on the sealing ring 21 and respectively located at two sides of the sealing ring 21. One side of the external extension portion 24 is connected to a side of the connecting portion 23 away from the sealing ring 21. The second sealing fin 25 is disposed on the external extension portion 24 and located at a side of the external extension portion 24 away from the connecting portion 23. The sealing ring 21, the connecting portion 23, and the external extension portion 24 cooperate to form a first sealing groove 202. The sealing ring 21, the first sealing fin 22, the connecting portion 23, the external extension portion 24, and the second sealing fin 25 work cooperatively to form a multilayer sealing structure.

The first sealing fin 22 and the second sealing fin 25 are respectively located at different positions, further enhancing the sealing effect, and preventing invasion of dust, water vapor and other impurities from different directions. The rear shell assembly 1 partially extends into the first sealing groove 202 formed by the sealing ring 21, the connecting portion 23, and the external extension portion 24. With such a structure, the sealing path is longer and more complex. Substances need to pass through the first sealing groove 202, thereby greatly improving the sealing reliability. Since the first sealing fin 22 and the connecting portion 23 are respectively disposed at the two sides of the sealing ring 21, the external extension portion 24 is connected to the connecting portion 23, and the second sealing fin 25 is disposed on the external extension portion 24, such a firm connecting relationship makes the sealing assembly 2 form a whole.

As shown in FIG. 6, the front shell assembly 3 further includes a front shell body 31. The guide member 340 is disposed at one side of the front shell body 31. Specifically, the output side plate 348 of the guide member 340 is connected to a side of the front shell body 31 away from the rear shell assembly 1. The through hole 344 is partially located at a side of the front shell body 31. The raw materials are obstructed by the front shell body 31 and guided down when flowing to the accommodating cavity 316 from the through hole 344. The front shell body 31 is provided with an adapting port 301. The front shell body 31 is disposed on the rear shell assembly 1. The sealing assembly 2 is clamped between the front shell body 31 and the rear shell assembly 1. The refrigerating barrel 4 can pass through the adapting port 301.

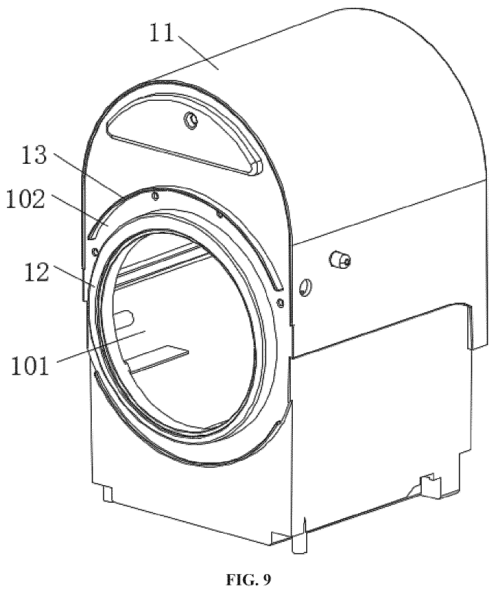

As shown in FIG. 9, the rear shell assembly 1 includes a rear shell body 11, a sealing convex ring 12, and a limiting rib 13. The rear shell body 11 is provided with the mounting hole 101. One side of the rear shell body 11 serves as a first side. The other side of the rear shell body 11 serves as the second side. The sealing convex ring 12 is disposed at the first side of the rear shell body 11. The sealing convex ring 12 surrounds the mounting hole 101. The limiting rib 13 is disposed on the rear shell body 11 and located outside the sealing convex ring 12. A second sealing groove 102 is formed between the sealing convex ring 12 and the limiting rib 13. The sealing assembly 2 is sleeved on the sealing convex ring 12 and partially extends to the second sealing groove 102. Since the sealing convex ring 12 surrounds the mounting hole 101, and the sealing assembly 2 is sleeved on the sealing convex ring 12, the sealing assembly 2 is firmly attached to the sealing convex ring 12 to form effective sealing for the mounting hole 101. This can prevent entry of external dust, water vapor, and other impurities into the device through the mounting hole 101, and protects such key components as the refrigerating barrel 4. Meanwhile, the second sealing groove 102 is formed between the sealing convex ring 12 and the limiting rib 13, and the sealing assembly 2 partially extends to the second sealing groove 102, which further enhances the sealing effect. To enter the inside of the device, external substances need to pass through the sealing assembly 2 and the sealing convex ring 12, and then pass through the second sealing groove 102. This greatly increases the invasion difficulty to realize multiple-sealing protection.

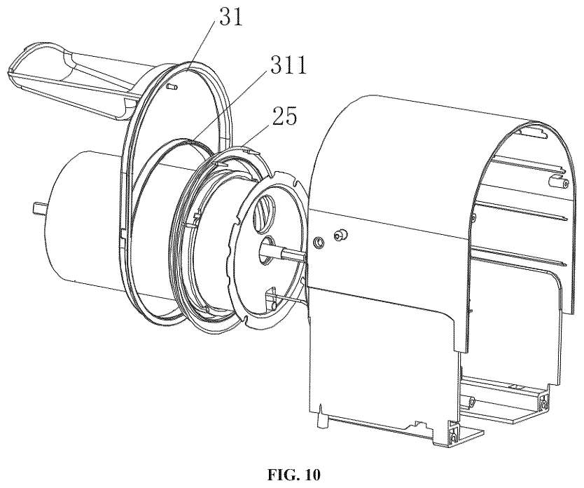

As shown in FIG. 10, a front convex rib 311 is further disposed on the front shell body 31. The front convex rib 311 surrounds the adapting port 301 and protrudes outward. Specifically, it protrudes to a side where the rear shell assembly 1 is located. The front convex rib 311 can abut against the sealing assembly 2 at the second sealing groove 102, and specifically abuts against the second sealing fin 25, thereby sealing the front shell body 31 and the rear shell body 11 to prevent leakage of the raw materials.

Further, referring to FIG. 8, the sealing ring 21 includes a sealing ring body 211 and a first sealing convex rib 212. The sealing ring body 211 is clamped between a wall of the mounting hole 101 and an outer wall of the refrigerating barrel 4. The first sealing convex rib 212 is disposed on the sealing ring body 211. The first sealing convex rib 212 is located between the sealing ring body 211 and the outer wall of the refrigerating barrel 4. The sealing ring body 211 clamped between the wall of the mounting hole 101 and the outer wall of the refrigerating barrel 4 forms a first sealing protection line. It can effectively obstruct entry of external dust, water vapor, moisture and other impurities or liquid in the accommodating cavity 316 into the rear shell body 11, and protect the refrigerating barrel 4 and other components in the rear shell body 11. Moreover, the first sealing convex rib 212 is disposed on the sealing ring body 211, and located between the sealing ring body 211 and the outer wall of the refrigerating barrel 4, which further enhances the sealing effect to form a second sealing protection line. Such a dual sealing structure greatly increases the difficulty of the external substances to enter the device, and improves the sealing reliability.

Referring to FIG. 8, the external extension portion 24 includes an external extension portion body 241 and a second sealing convex rib 242. The external extension portion body 241 is clamped between the rear shell assembly 1 and the front shell body 31 of the front shell assembly 3. The second sealing convex rib 242 is disposed on the external extension portion body 241. The second sealing convex rib 242 is located between the external extension portion body 241 and the front shell assembly 3. The external extension portion body 241 clamped between the rear shell assembly 1 and the front shell assembly 3 forms a basic sealing layer, which can effectively obstruct entry of the external dust, water vapor, moisture and the like into the device, and prevent components in the device from being affected by an external environment. The second sealing convex rib 242 disposed between the external extension portion body 241 and the front shell body 31 of the front shell assembly 3 serves as an additional sealing protection line to further enhance the sealing effect. Such a dual sealing structure greatly improves the sealing reliability to ensure normal operation of the device. The second sealing convex rib 242 usually has a certain degree of elasticity. When the front shell body 31 of the front shell assembly 3 is mounted, it is squeezed to deform, and thus is firmly attached to a surface of the front shell assembly 3. The firm attachment can fill a potentially small gap between the external extension portion body 241 and the front shell assembly 3 to reduce the leakage.

Referring to FIG. 7, a central axis of the sealing ring 21 coincides with a central axis of the refrigerating barrel 4. The stirring and refrigeration assembly 360 is disposed at an outer side of the refrigerating barrel 4. The stirring blades of the stirring and refrigeration assembly 360 rotate around the central axis of the refrigerating barrel 4, so as to stir the frozen or semi-frozen product on a surface of the refrigerating barrel 4. A central axis of the external extension portion 24 is parallel to, but not coincident with, the central axis of the sealing ring 21. A distance from the central axis of the external extension portion 24 to the bottom of the barrel body 310 is greater than a distance from the central axis of the sealing ring 21 to the bottom of the barrel body 310. Specifically, a distance L from a central axis of the external extension portion body 241 to the bottom of the barrel body 310 is greater than the distance H from the central axis of the sealing ring 21 to the bottom of the barrel body 310. Since the external extension portion body 241 is clamped between the rear shell assembly 1 and the front shell body of the front shell assembly 3, and is specifically clamped between the rear shell assembly 1 and the adapting port 301, a distance from the sealing ring 21 to the bottom of the barrel body 310 is less than a distance from the adapting port 301 to the bottom of the barrel body 310, and thus the refrigerating barrel 4 inserted into the adapting port 301 can be closer to the bottom of the barrel body 310. In this way, the stirring blades at a periphery of the refrigerating barrel 4 can push the frozen or semi-frozen product at the bottom of the barrel body 310 as much as possible, so as to improve the overall stirring uniformity, and prevent accumulation of the frozen or semi-frozen product at the bottom of the barrel body 310.

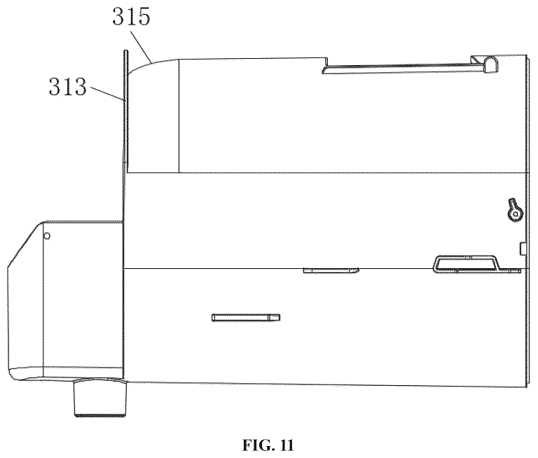

Referring to FIG. 11, one end of the barrel body 310 is further provided with a front end plate 313. A lower portion of the front end plate 313 is provided with an output port 324. The output port 324 is provided with an output valve 326. The output valve 326 is configured to seal or open the output port 324. Since the output port 324 communicates with the accommodating cavity 316, the frozen or semi-frozen product that is stirred, refrigerated and formed can be output through the output port 324. An upper surface of an end of the barrel body 310 away from the feed port is provided with an arc-shaped curved surface 315 that is smoothly arranged. The arc-shaped curved surface 315 is disposed between an upper surface of an inner wall of the barrel body 310 and the front end plate. The arc-shaped curved surface 315 gradually curves and transitions from the upper surface of the inner wall of the barrel body 310 toward the lower portion of the front end plate 313. The single smoothly arranged manner means that the arc-shaped curved surface 315 is integrally formed by a single curved surface, and the arc-shaped curved surface 315 is smooth and continuous. With the arc-shaped curved surface 315, the frozen or semi-frozen product in the barrel body 310 can move from an upper portion of the barrel body 310 to the output port 324 through the stirring and refrigeration assembly 360, facilitating discharge. Meanwhile, the frozen or semi-frozen product not discharged from the output port 324 timely can also flow through the arc-shaped curved surface, and is not obstructed at the output port 324.

Further, the arc-shaped curved surface 315 smoothly extends along a circumferential side of the barrel body 310 from one side of the barrel body 310 to the other side of the barrel body 310. The circumferential side of the barrel body 310 refers to an end-to-end ring-shaped (circular, elliptical, quasi-circular or quasi-elliptical) side formed around the central axis of the barrel body 310 in a longitudinal section of the barrel body 310. The arc-shaped curved surface 315 is disposed at the circumferential side. With a starting end located at one side of the barrel body 310, the arc-shaped curved surface 315 reaches to the other side of the barrel body 310 along the circumferential side of the barrel body 310. In an overall structure of the arc-shaped curved surface 315, there are no structures such as grooves and corners, thereby forming a smooth and pit-free surface. Without the structures such as grooves and corners, the arc-shaped curved surface 315 facilitates better flowing of the frozen or semi-frozen product.

An embodiment of the present disclosure further provides a beverage maker, including the stirring barrel described above. The stirring barrel includes the barrel body 310, the guide member 340, and the stirring and refrigeration assembly 360. The barrel body 310 is provided with the feed port 312 and the accommodating cavity 316. The feed port 312 communicates with the accommodating cavity 316. The feed port312 is provided with the extension portion 314. The guide member 340 is disposed in the barrel body 310.The input port 342 of the guide member 340 is blocked through the extension portion 314 at the feed port 312. When the raw materials are to be injected, the raw materials enter the guide member 340 through the feed port 312, and the raw materials are guided to the input port 342 through the guide member 340 and flows to the accommodating cavity 316 through the input port 342. With the extension portion 314 for blocking the input port 342, the beverage maker realizes injection of the raw materials, and prevents splashing of the raw materials from the feed port 312 in case of an excessively quick injection speed of the raw materials, thereby avoiding contamination to the beverage maker and the worktable to improve the user experience.

In addition, the stirring barrel further includes the rear shell assembly, the refrigerating barrel, and the sealing assembly. The rear shell assembly 1 is provided with the mounting hole 101. The sealing assembly 2 is disposed along the circumferential direction of the mounting hole 101, with one part located at the first side of the rear shell assembly 1, and the other part extending to the second side. This forms surrounding sealing for the mounting hole 101. In addition, during mounting, only the sealing assembly 2 needs to be accurately mounted around the mounting hole 101 of the rear shell assembly 1. Then, the refrigerating barrel 4 passes through the sealing hole 201. At last, the front shell assembly 3 is mounted. Such a modular mounting method makes the mounting less complex, and improves the production efficiency.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A stirring barrel, applied to a beverage maker, wherein the beverage maker comprises a housing assembly and a drive assembly; the drive assembly is disposed in the housing assembly; and the stirring barrel comprises:
a barrel body, wherein the barrel body is disposed on the housing assembly; the barrel body is provided with a feed port and an accommodating cavity; the feed port communicates with the accommodating cavity; and the feed port is provided with an extension portion;
a guide member, wherein the guide member is disposed in the barrel body; the guide member corresponds to the feed port; the guide member is provided with an input port; the input port communicates with the accommodating cavity and the feed port; and the extension portion is configured to block the input port; and
a stirring and refrigeration assembly, wherein the stirring and refrigeration assembly is disposed in the accommodating cavity; the stirring and refrigeration assembly is connected to the drive assembly;
and the stirring and refrigeration assembly is configured to stir and refrigerate raw materials injected into the accommodating cavity.

2. The stirring barrel according to claim 1, wherein one end of the barrel body is further provided with a front end plate; a lower portion of the front end plate is provided with an output port; the output port is provided with an output valve; and the output valve is configured to seal or open the output port;
an upper surface of an end of the barrel body away from the feed port is provided with an arc-shaped curved surface that is smoothly arranged; the arc-shaped curved surface is disposed between an upper surface of an inner wall of the barrel body and the front end plate; and the arc-shaped curved surface gradually curves and transitions from the upper surface of the inner wall of the barrel body toward the lower portion of the front end plate; and
the arc-shaped curved surface smoothly extends along a circumferential side of the barrel body from one side of the barrel body to the other side of the barrel body.

3. The stirring barrel according to claim 1, further comprising:
a rear shell assembly, wherein the rear shell assembly is provided with a mounting hole;
a sealing assembly, wherein the sealing assembly is provided with a sealing hole; the sealing assembly is disposed on the rear shell assembly; the sealing assembly is disposed along a circumferential direction of the mounting hole; the sealing assembly comprises one part located at a first side of the rear shell assembly, and the other part extending to a second side of the rear shell assembly after passing through the mounting hole; and the second side is opposite to the first side;
a refrigerating barrel, wherein the refrigerating barrel comprises a refrigerating barrel body and a sealing plate; the refrigerating barrel body partially passes through the sealing hole from the first side of the rear shell assembly and extends out from the second side of the rear shell assembly; the sealing plate is located at an end of the refrigerating barrel body extending to the second side and disposed around the refrigerating barrel body; and the sealing assembly is partially clamped between the sealing plate and the second side of the rear shell assembly; and
a front shell assembly, wherein the front shell assembly is disposed on the rear shell assembly and located at the first side of the rear shell assembly; the sealing assembly is partially clamped between the first side of the rear shell assembly and the front shell assembly; and the front shell assembly comprises the guide member;
the sealing assembly comprises a sealing ring, a connecting portion, and an external extension portion; the sealing ring is provided with the sealing hole; one side of the external extension portion is connected to a side of the connecting portion away from the sealing ring; and the sealing ring, the connecting portion, and the external extension portion cooperate to form a first sealing groove; and
a central axis of the sealing ring coincides with a central axis of the refrigerating barrel; and a distance from a central axis of the external extension portion to a bottom of the barrel body is greater than a distance from the central axis of the sealing ring to the bottom of the barrel body.

4. The stirring barrel according to claim 1, wherein the guide member comprises a guide bottom plate and an output side plate; an end of the guide bottom plate away from the extension portion serves as a first end; the first end of the guide bottom plate corresponds to the feed port; an end of the guide bottom plate close to the extension portion serves as a second end; the second end of the guide bottom plate is connected to the output side plate; and a preset included angle is formed between the guide bottom plate and the output side plate;
the extension portion is configured to block the output side plate and block at least a part of the guide bottom plate; and
the guide bottom plate is obliquely disposed; the first end of the guide bottom plate extends obliquely downward to the second end of the guide bottom plate; and a height of the first end of the guide bottom plate is greater than a height of the second end of the guide bottom plate.

5. The stirring barrel according to claim 4, wherein the input port is formed in the output side plate; the input port comprises a plurality of through holes; and the plurality of through holes are disposed at intervals; and
a junction between the guide bottom plate and the output side plate is arc-shaped; the plurality of through holes are formed at the junction between the guide bottom plate and the output side plate; and
the plurality of through holes each extend from the output side plate to the second end of the guide bottom plate.

6. The stirring barrel according to claim 3, wherein the sealing assembly further comprises a first sealing fin and a second sealing fin; the first sealing fin and the connecting portion are disposed on the sealing ring and respectively located at two sides of the sealing ring; and the second sealing fin is disposed on the external extension portion and located at a side of the external extension portion away from the connecting portion.

7. The stirring barrel according to claim 6, wherein the external extension portion comprises an external extension portion body and a second sealing convex rib; the external extension portion body is clamped between the rear shell assembly and the front shell assembly; and the second sealing convex rib is disposed on the external extension portion body and located between the external extension portion body and the front shell assembly.

8. The stirring barrel according to claim 3, wherein the front shell assembly further comprises a front shell body; the front shell body is disposed on the rear shell assembly and located at the first side of the rear shell assembly; the guide member is disposed at one side of the front shell body; the front shell body is provided with an adapting port; and the refrigerating barrel passes through the adapting port;
the rear shell assembly comprises a rear shell body, a sealing convex ring, and a limiting rib; the rear shell body is provided with the mounting hole; the sealing convex ring is disposed at a first side of the rear shell body; the sealing convex ring surrounds the mounting hole; the limiting rib is located outside the sealing convex ring and forms a second sealing groove with the sealing convex ring; and
the sealing assembly is sleeved on the sealing convex ring and partially extends to the second sealing groove; and
a front convex rib is further disposed on the front shell body; the front convex rib surrounds the adapting port and protrudes outward; and the front convex rib is capable of abutting against the sealing assembly at the second sealing groove.

9. The stirring barrel according to claim 6, wherein the sealing ring comprises a sealing ring body and a first sealing convex rib; the sealing ring body is clamped between a wall of the mounting hole and an outer wall of the refrigerating barrel; and the first sealing convex rib is disposed on the sealing ring body, and located between the sealing ring body and the outer wall of the refrigerating barrel.

10. A beverage maker, comprising the stirring barrel according to claim 1.
